(19) United States
(12) Patent Application Publication
(10) Pub. No.: US 2023/0052301 A1
(43) Pub. Date: Feb. 16, 2023

(54) INFORMATION PROCESSING APPARATUS, AND METHOD

(71) Applicant: Real Inc., Tokyo (JP)

(72) Inventor: Noriaki KIMOTO, Tokyo (JP)

(73) Assignee: Real Inc., Tokyo (JP)

(21) Appl. No.: 17/976,050

(22) Filed: Oct. 28, 2022

Related U.S. Application Data
(63) Continuation of application No. PCT/JP2021/018509, filed on May 14, 2021.

(30) Foreign Application Priority Data
May 14, 2020 (JP) 2020-085301
May 14, 2021 (JP) 2021-082696

(51) Int. Cl. G06Q 40/06

(52) U.S. Cl. CPC G06Q 40/06

(57) ABSTRACT

A control unit performs: presenting information of each business operator or business that is a candidate for investment to the user; receiving an operation to select at least one business operator or business from the user; performing an analysis on a financial condition of at least one selected business operator or business; and presenting a result of the analysis. The presenting includes creating one graph in which the financial items of the selected business operator or business or the financial items of a combination of the selected business operators or businesses are associated with each other and presenting in the graph the financial items and comparison values of financial items of each of a predetermined sample number of business operators or businesses in a form that enable comparison therebetween on the same screen.

### CROSS-REFERENCE TO RELATED APPLICATION

This application is a Continuation Application of No. PCT/JP2021/018509, filed on May 14, 2021, and the PCT application is based upon and claims the benefit of priority from Japanese Patent Application No. 2020-085301, filed on May 14, 2020, and Japanese Patent Application No. 2021-082696, filed on May 14, 2021, the entire contents of which are incorporated herein by reference.

### FIELD

The present disclosure relates to an information processing apparatus, and a method.

### BACKGROUND

There are technologies that support investor’s activities of investing in investment targets. Examples of the investment targets include business operators, real estates, commodities (resources), stocks, and bonds. As disclosed in Japanese Patent Application Publication No. 2008-033714, conventionally, there has been a technology that allows a single user owning a plurality of rental real estates to collectively view the income and expense statuses of the respective real estates on a single website.

However, it is not easy to analyze real estate information as investment information when conducting asset management. Specifically, in order to utilize real estate information as investment information, it is necessary to grasp income and expense information, comparison of multiple real estates, and borrowing status with respect to information on real estates currently in possession, and to combine the information with information on a real estate under consideration for purchase or sale to perform analyses such as a future income and expense analysis, a comparative analysis on multiple real estates, and a borrowing status analysis.

This does not apply to real estate information only, and when investing extensively in a business operator or a business as asset management, it is not easy to analyze the financial condition of the business operator. Specifically, in order to utilize information on a business operator or a business as investment information, it may be good to compare information on a business operator under consideration for new investment with information on a business operator currently under investment or other business operators' information to perform a financial condition analysis.

The system described in Japanese Patent Application Publication No. 2008-033714 is not provided with a function for utilizing information on a business operator or a business in the above-described manner.

### BRIEF DESCRIPTION OF THE DRAWINGS

FIG. 1 shows an overall configuration of a real estate management system 1.

FIG. 2 is a block diagram of a user’s terminal apparatus 10 constituting the real estate management system 1 of the first embodiment.

FIG. 3 shows a functional configuration of a server 20 constituting the real estate management system 1 of the first embodiment.

FIG. 4 shows data structures of a user information database 281 and a real estate information database 282 stored in the server 20.

FIG. 5 is a flowchart showing an example of the flow of an analysis performed by the real estate management system 1 of the first embodiment on at least one real estate in possession or under consideration for purchase designated by the user.

FIG. 6 shows a screen example of the user’s terminal apparatus 10.

FIG. 7 shows a screen example of the user’s terminal apparatus 10.

FIG. 8 shows a screen example of the user’s terminal apparatus 10.

FIG. 9 shows data structures of a user information database 281A and a business operator information database 282A stored in the server 20.

FIG. 10 is a flowchart showing an example of the flow of an analysis performed on at least one business operator in possession or under consideration for purchase designated by the user in the second embodiment.

FIG. 11 shows a screen example of the user’s terminal apparatus 10.

### DETAILED DESCRIPTION

Hereinafter, embodiments of the present disclosure will be described with reference to the drawings. In the following description, identical parts are denoted by the same reference numeral. Their names and functions are also the same. Therefore, their detailed descriptions will not be repeated.

According to one embodiment, there is provided an information processing apparatus comprising a control unit and a storage unit and configured to provide investment information to a user. The control unit performs: presenting information of each business operator or business that is a candidate for investment to the user; receiving an operation to select at least one business operator or business from the user; performing an analysis on a financial condition of at least one selected business operator or business; and presenting a result of the analysis, wherein the performing an analysis includes performing a financial analysis based on information of the at least one business operator or business selected by the user and analyzing each of a plurality of financial items, and the presenting includes creating one graph in which the financial items of the selected business operator or business or the financial items of a combination of the selected business operators or businesses are associated with each other and presenting in the graph the financial items and comparison values of financial items of each of a predetermined sample number of business operators or businesses in a form that enable comparison therebetween on the same screen.

### First Embodiment

An embodiment will be described below in which an analysis is performed on at least one real estate in possession or under consideration for purchase designated by the user.

### 1 Overall Configuration of Real Estate Management System 1

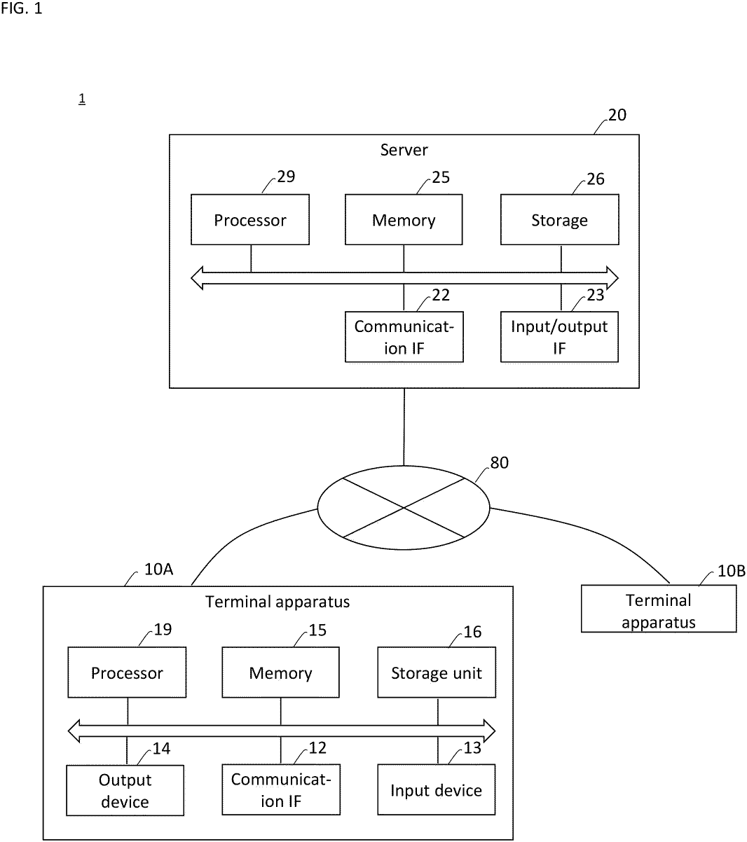

FIG. 1 shows an overall configuration of a real estate management system 1.

The real estate management system 1 is a system for performing an analysis on the management of real estate. As shown in FIG. 1, the real estate management system 1 includes a plurality of terminal apparatuses (terminal apparatus 10A and terminal apparatus 10B are shown in FIG. 1; hereinafter sometimes collectively referred to as a “terminal apparatus 10”) and a server 20. The terminal apparatus 10 and the server 20 are connected to communicate via a network 80. The network 80 is constituted by a wired or wireless network.

The terminal apparatus 10 is an apparatus operated by a user of a real estate manager. The terminal apparatus 10 is implemented by, for example, a stationary personal computer (PC) or a laptop PC. As shown in FIG. 1, the terminal apparatus 10 includes a communication interface (IF) 12, an input device 13, an output device 14, a memory 15, a storage unit 16, and a processor 19.

The communication IF 12 is an interface for the terminal apparatus 10 to input and output signals for communication with an external apparatus. The input device 13 is an input device (such as a touch panel, a touch pad, a pointing device such as a mouse, or a keyboard) for receiving an input operation from the user. The output device 14 is an output device (such as a display, or a speaker) for presenting information to the user. The memory 15 is used to temporarily store a program, data to be processed by the program, etc., and the like, and is a volatile memory such as a dynamic random access memory (DRAM). The storage unit 16 is a storage device for storing data, and is, for example, a flash memory or a hard disc drive (HDD). The processor 19 is hardware for executing an instruction set described in a program, and is composed of an arithmetic unit, a register, a peripheral circuit, and the like.

The server 20 is a device for managing information on each user and information on each real estate. The server 20 is a computer connected to the network 80.

As shown in FIG. 1, the server 20 includes a communication IF 22, an input/output IF 23, a memory 25, a storage 26, and a processor 29.

The communication IF 22 is an interface for the server 20 to input and output signals for communication with an external apparatus. The input/output IF 23 functions as an interface with an input device for receiving an input operation from the user and an output device for presenting information to the user. The memory 25 is used to temporarily store a program, data to be processed by the program, etc., and the like, and is a volatile memory such as a dynamic random access memory (DRAM). The storage 26 is a storage device for storing data, and is, for example, a flash memory or a hard disc drive (HDD). The processor 29 is hardware for executing an instruction set described in a program, and is composed of an arithmetic unit, a register, a peripheral circuit, and the like.

### 1.1 Configuration of Terminal Apparatus 10

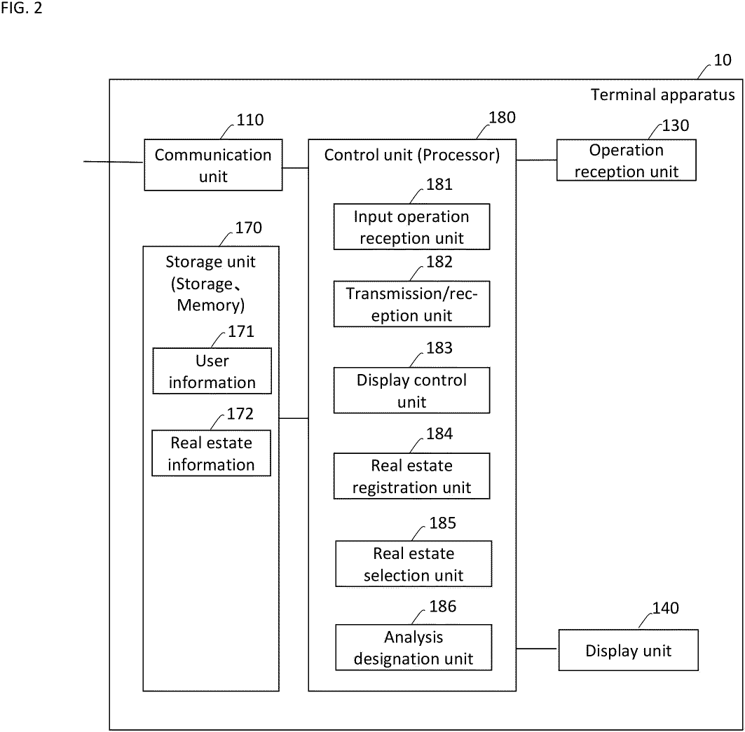

FIG. 2 is a block diagram of the terminal apparatus 10 constituting the real estate management system 1 of the first embodiment. As shown in FIG. 2, the terminal apparatus 10 includes a communication unit 110, an operation reception unit 130, a display unit 140, a storage unit 170, and a control unit 180. The terminal apparatus 10 also has functions and configurations not particularly shown in FIG. 2 (such as a battery for holding electric power, and a power supply circuit for controlling supply of electric power from the battery to each circuit). As shown in FIG. 2, the blocks included in the terminal apparatus 10 are electrically connected by buses or the like.

The communication unit 110 is a component for the terminal apparatus 10 to communicate with an external apparatus.

The operation reception unit 130 has a mechanism for receiving an input operation by the user. Examples of the operation reception unit 130 include a mouse, a keyboard, a touch panel, and the like.

The display unit 140 displays data such as an image, a moving image, and text in accordance with control of the control unit 180. The display unit 140 is implemented by, for example, a liquid crystal display.

The storage unit 170 is constituted by, for example, a flash memory or the like, and stores data and programs used by the terminal apparatus 10. In one situation, the storage unit 170 stores user information 171 and real estate information 172. The user information 171 and the real estate information 172 are information managed by the server 20 (such as a user information database 281 and a real estate information database 282 to be described later). The terminal apparatus 10 accesses the server 20 through a browser or the like to perform processing based on the user information 171 and the real estate information 172.

The user information 171 is information on a user who manages real estate using the real estate management system 1. The user information 171 is, for example, information on a user who utilizes the real estate management system 1 through the terminal apparatus 10. The user information includes information for identifying the user (user ID), information on real estates registered by the user, and the like. For the real estates registered by the user, information on each real estate is stored according to the status of the real estate (such as in possession, sold, under consideration, and consideration suspended).

The real estate information 172 is information on real estates in the real estate management system 1. The real estate information includes information for identifying each real estate (real estate ID), and the physical matters, form of right, operating income, operating expenses, acquisition price, borrowing status, and the like of each real estate.

The control unit 180 controls the operation of the terminal apparatus 10 by reading a program stored in the storage unit 170 and executing instructions included in the program. The control unit 180 operates in accordance with the program to perform the functions as an input operation reception unit 181, a transmission/reception unit 182, a display control unit 183, a real estate registration unit 184, a real estate selection unit 185, and an analysis designation unit 186.

The input operation reception unit 181 performs a process of receiving a user’s input operation on an input device such as a mouse or a keyboard.

The transmission/reception unit 182 performs a process by which the terminal apparatus 10 transmits and receives data to and from an external apparatus such as the server 20 in accordance with a communication protocol.

The display control unit 183 controls a display process of the display unit 140.

The real estate registration unit 184 performs a process of receiving an operation to register a real estate from the user. For example, the real estate registration unit 184 receives an operation to register information such as the physical matters, right state, operating income, operating expenses, acquisition price, and borrowing status of each real estate in the possession of the user. The real estate registration unit 184 also receives from the user an operation to designate the status of each real estate as in possession, sold, under consideration, consideration suspended, or the like.

The real estate selection unit 185 performs a process of receiving from the user an operation to select a real estate to be subjected to an analysis to be described later. For example, the real estate selection unit 185 presents all real estates registered by the user according to the status of the real estate, and receives from the user an operation to select at least one real estate in possession or under consideration for purchase.

The analysis designation unit 186 receives from the user an operation to designate a type of analysis to be performed on at least one selected real estate. For example, the analysis designation unit 186 presents all types of analysis that can be executed, which will be described later, and receives from the user a designation to perform an income and expense analysis on multiple real estates.

### 1.3 Functional Configuration of Server 20

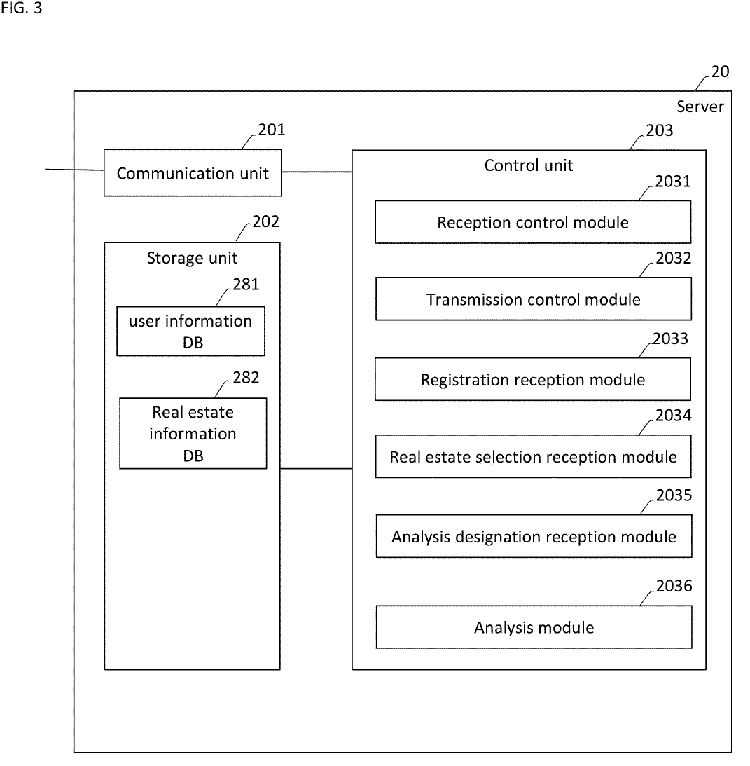

FIG. 3 shows a functional configuration of the server 20. As shown in FIG. 3, the server 20 performs functions as a communication unit 201, a storage unit 202, and a control unit 203.

The communication unit 201 performs a process by which the server 20 communicates with an external apparatus.

The storage unit 202 stores data and programs used by the server 20. The storage unit 202 stores a user information database 281, a real estate information database 282, and the like.

The user information database 281 is a database for holding information of a user who utilizes the real estate management system 1. Details will be described later.

The real estate information database 282 is a database for holding real estate information stored in the real estate management system 1. Details will be described later.

The control unit 203 performs the functions shown as various modules by the processor of the server 20 performing processes in accordance with programs.

A reception control module 2031 controls a process by which the server 20 receives a signal from an external apparatus in accordance with a communication protocol.

A transmission control module 2032 controls a process by which the server 20 transmits a signal to an external apparatus in accordance with a communication protocol.

A registration reception module 2033 controls a process by which the server 20 receives an operation to register a real estate from the terminal apparatus 10.

A real estate selection reception module 2034 controls a process by which the server 20 receives from the terminal apparatus 10 an operation to select at least one real estate to be subjected to an analysis to be described later. For example, the real estate selection reception module 2034 receives from the terminal apparatus 10 an operation to select at least one real estate in possession or under consideration for purchase.

An analysis designation reception module 2035 controls a process by which the server 20 receives from the terminal apparatus 10 an operation to designate a type of analysis to be described later. For example, the analysis designation reception module 2035 receives from the terminal apparatus 10 a designation to perform an income and expense analysis on multiple of real estates.

An analysis module 2036 controls a process by which the server 20 performs a predetermined analysis on at least one real estate selected by the user. For example, the analysis module 2036 analyzes the income and expense status designated by the user for multiple real estates in possession or under consideration for purchase selected by the user.

### 2 Data Structure

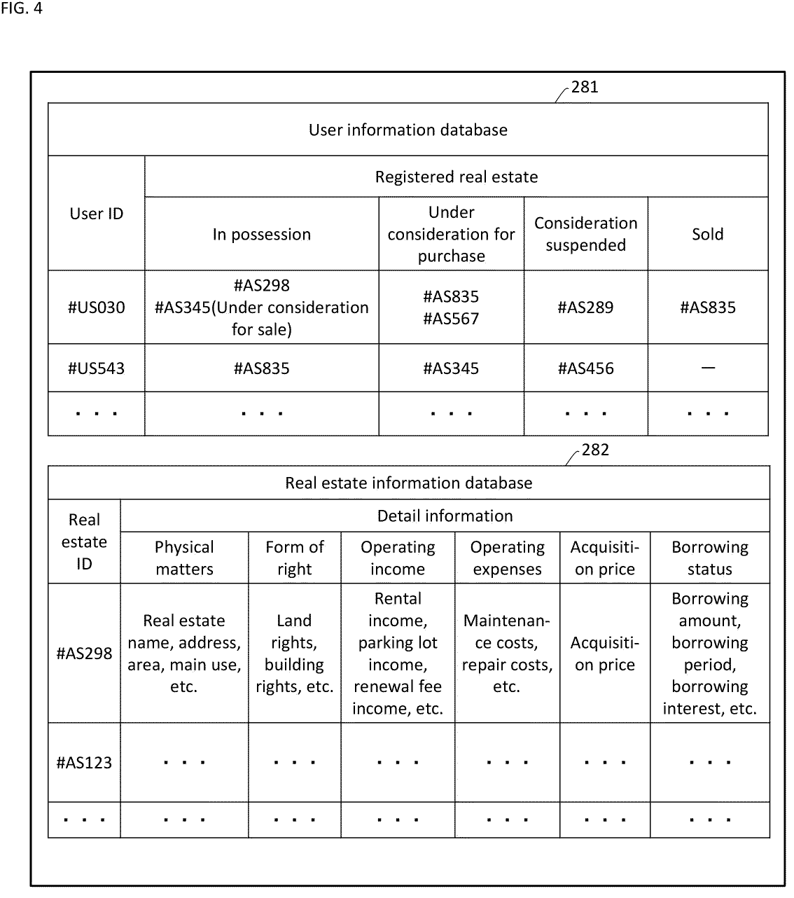

FIG. 4 shows data structures of the user information database 281 and the real estate information database 282 stored in the server 20.

As shown in FIG. 4, each record of the user information database 281 includes an item “user ID”, an item “name”, an item “registered real estate”, and the like.

The item “user ID” is information for identifying each user.

The item “registered real estate” is information of a real estate that each user registered when utilizing the real estate management system 1. Specifically, as the “registered real estate”, the real estate ID of each real estate is stored according to the status of the real estate designated by the user (such as in possession, under consideration for purchase, consideration suspended, or sold).

For example, when the user registers detailed information of a real estate in the possession of the user, the server 20 stores the real estate as a real estate “in possession”. Further, when the user searches from the real estate information stored in the real estate management system 1 using a predetermined search condition (use, address, area, age of building, etc.) and designates a real estate satisfying the search condition as a real estate under consideration for purchase, the server 20 stores the real estate as a real estate “under consideration for purchase”.

Further, in the user information database 281, among the real estates in the possession of the user, a real estate that the user is considering to sell is distinguished and stored as a real estate “under consideration for sale”.

Each record of the real estate information database 282 includes an item “real estate ID”, an item “real estate name”, an item “detailed information”, and the like.

The item “real estate ID” is information for identifying each real estate.

The item “detailed information” is detailed information on each real estate, and specifically includes the physical matters, form of right, operating income, operating expenses, acquisition price, borrowing status, and the like of each real estate. Detailed information of real estates is used when performing an analysis on real estates.

The item “physical matters” is information for specifying each real estate, and specifically includes information on real estate name, address, main use, details of use, structure, number of floors, total land area, total building floor area, completion date, and the like.

The item “form of right” is information indicating rights related to each real estate, specifically, information indicating land rights, building rights, and the like, and includes information on land rights, building rights, total number of tenants, leasable area, security deposit, guarantee deposit, land lease rights, and the like.

The item “operating income” is information indicating the income obtained by operating each real estate, and specifically includes information on room rental income, common service fee income, utilities income, parking lot income, key money/right fee income, renewal fee income, bad debt loss, and the like.

The item “operating expenses” is information indicating the expenses incurred by operating each real estate, and specifically includes information on maintenance costs, utilities costs, repair costs, restoration costs, property management fees, tenant recruitment costs, taxes and public dues, non-life insurance premiums, land rent paid, and the like.

The item “acquisition price” is information indicating the amount of money paid to purchase each real estate.

The item “borrowing status” is information indicating the status of borrowing from a financial institution to acquire each real estate, and specifically includes information on borrowing date, borrowing financial institution, branch name, borrowing amount, contract borrowing period, borrowing interest, and the like.

### 3 Operation

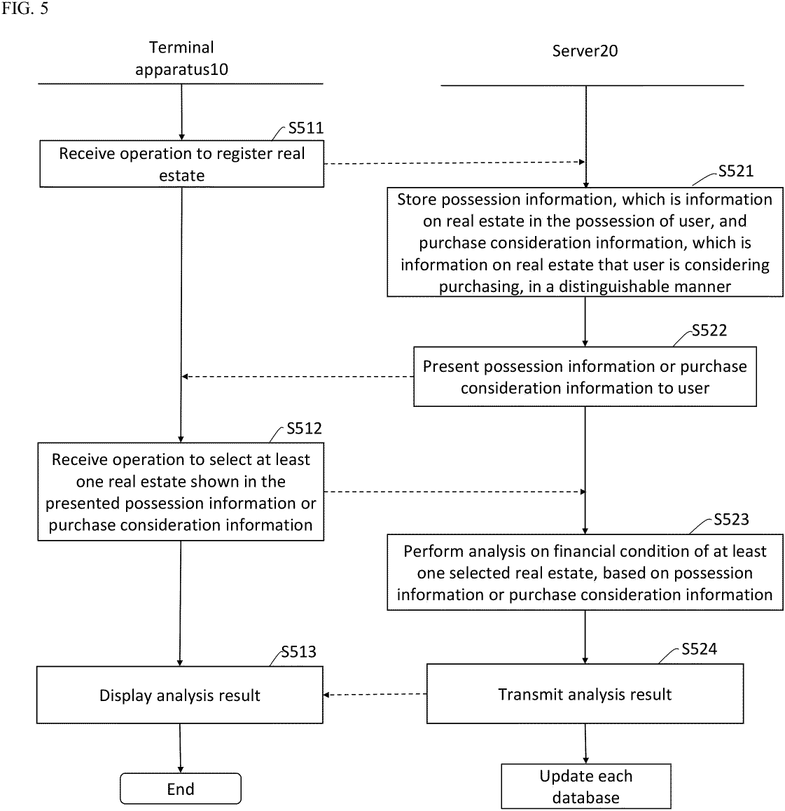

Hereinafter, with reference to FIG. 5, the analysis on real estates by the real estate management system 1 according to the first embodiment will be described.

FIG. 5 is a flowchart showing an example of the flow of an analysis performed by the terminal apparatus 10 on at least one real estate in possession or under consideration for purchase designated by the user.

In step S511, the terminal apparatus 10 receives from the user an operation to designate a real estate. For example, the terminal apparatus 10 receives from the user an operation to input detailed information on a real estate in possession. Alternatively, the terminal apparatus 10 receives from the user an operation to designate a real estate satisfying a desired purchase condition as a real estate “under consideration for purchase”.

In step S521, in response to the registration of a real estate by the user, the server 20 stores possession information, which is information on real estates in the possession of the user, and purchase consideration information, which is information on real estates that the user is considering purchasing, in a distinguishable manner.

For example, the server 20 stores information of each real estate in the user information database 281 and the real estate information database 282 according to the status of the real estate designated by the user (in possession, under consideration for purchase, consideration suspended, sold, etc.) in such a manner that “real estates in possession” are distinguished from “real estates under consideration for purchase”.

Further, the server 20 may store information on real estates under consideration for sale, which is information on real estates that the user is considering selling, in such a manner as to be distinguished from the possession information. For example, when the user designates a given real estate in the possession of the user as a real estate under consideration for sale, the real estate is stored with the status “under consideration for sale”, thereby being stored in a manner distinguished from the other real estates in possession.

In step S522, the server 20 presents the possession information or the purchase consideration information to the user. For example, the server 20 presents to the user various types of information (physical matters, form of right, operating income, operating expenses, etc.) of the real estates in the possession of the user or under consideration for purchase by the user.

In step S512, the terminal apparatus 10 receives from the user an operation to select at least one real estate shown in the presented possession information or purchase consideration information. For example, when the user wishes to know the business condition when some real estates under consideration for purchase are purchased in addition to all the real estates in the possession of the user, the user performs an operation to select all the real estates in the possession of the user and some real estates under consideration for purchase.

In step S523, the server 20 performs an analysis on the business condition of at least one selected real estate on the basis of the possession information or the purchase consideration information. For example, the server 20 performs the following analysis.

### Income and Expense Analysis

The server 20 performs an income and expense analysis on at least one real estate in possession or under consideration for purchase selected by the user.

### 1) Income and Expense Analysis on Each Real Estate

The server 20 calculates, as income and expense items, the operating income, rent level, operating expenses, non-life insurance premiums, repair costs, maintenance costs, and the like of each real estate in possession or under consideration for purchase selected by the user on the basis of the detailed information of the real estate to perform an income and expense analysis on the real estate. The server 20 also calculates the operating income, rent level, operating expenses, non-life insurance premiums, repair costs, maintenance costs, and the like per unit area (for example, one square meter (1 m²)) of each real estate selected by the user on the basis of the detailed information of the real estate to perform a per-square-meter income and expense analysis of the real estate.

Further, the server 20 may extract a predetermined sample number of real estates on the basis of the real estate information stored in the real estate management system 1 in addition to the real estate information registered by the user, and calculate the first quartile, median, and third quartile of each income and expense item (operating income, rent level, operating expenses, non-life insurance premiums, repair costs, maintenance costs, etc.) to perform a comparative analysis with the corresponding income and expense item of each real estate in possession or under consideration for purchase selected by the user.

Further, the server 20 may calculate a parameter evaluating each real estate in possession or under consideration for purchase selected by the user on the basis of the detailed information of the real estate. For example, the server 20 comprehensively evaluates the income and expense status of each real estate on the basis of the calculated income and expense items, and calculates an income and expense comprehensive evaluation parameter of the real estate in numerical form.

Further, the server 20 may predict future income and expense item (operating income, rent level, operating expenses, non-life insurance premiums, repair costs, maintenance costs, etc.) of each real estate in possession or under consideration for purchase selected by the user on the basis of the detailed information of the real estate to perform a future income and expense analysis on the real estate.

### 2) Income and Expense Analysis on Multiple Real Estates

The server 20 calculates, as income and expense items, the operating income, rent level, operating income, non-life insurance premiums, repair costs, maintenance costs, and the like for a combination of multiple real estates in possession or under consideration for purchase selected by the user on the basis of the detailed information of the multiple real estates to perform an income and expense analysis for the combination of the multiple real estates. The server 20 also calculates the operating income, rent level, operating income, non-life insurance premiums, repair costs, maintenance costs, and the like per square meter for a combination of multiple real estates in possession or under consideration for purchase selected by the user on the basis of the detailed information of the multiple real estates to perform a per-square-meter income and expense analysis for the combination of the multiple real estates.

Further, the server 20 may extract a predetermined sample number of real estates on the basis of other users' information on real estates in possession or under consideration for purchase, i.e., real estate information other than the real estate information registered by the user, and calculate the first quartile, median, and third quartile of each income and expense item (operating income, rent level, operating expenses, non-life insurance premiums, repair costs, maintenance costs, etc.) to perform a comparative analysis with the corresponding income and expense item for a combination of multiple real estates in possession or under consideration for purchase selected by the user.

Further, the server 20 may calculate a parameter for evaluating multiple real estates in possession or under consideration for purchase selected by the user in combination on the basis of the detailed information of the multiple real estates. For example, the server 20 comprehensively evaluates an income and expense status for a combination of multiple real estates on the basis of the income and expense items of the combination of the multiple real estates to calculate an income and expense comprehensive evaluation parameter for the combination of the multiple real estates in numerical form.

As a result, for at least one real estate in possession or under consideration for purchase selected by the user, not only an income and expense analysis for each real estate, but also an income and expense analysis for a combination of multiple real estates can be performed. For example, an income and expense analysis can be performed for the case where a real estate under consideration for purchase is purchased in addition to the real estates in possession. Therefore, information useful for real estate investment can be provided.

Further, the server 20 may predict future income and expense items (operating income, rent level, operating expenses, non-life insurance premiums, repair costs, maintenance costs, etc.) of multiple real estates in possession or under consideration for purchase selected by the user on the basis of the detailed information of the multiple real estates to perform a future income and expense analysis for the combination of the multiple real estates.

### 3) Extraction of Real Estate Similar to Selected Real Estate

The server 20 extracts real estimate information similar to at least one real estate in possession or under consideration for purchase selected by the user from other users' possession information or purchase consideration information on the basis of the income and expense analysis on the at least one selected real estate.

For example, the server 20 extracts real estate information similar to the income and expense state of a real estate under consideration for purchase selected by the user from other users' possession information. Further, the server 20 may calculate, based on the extracted similar real estate information, income and expense items (operating income, rent level, operating expenses, non-life insurance premiums, repair costs, maintenance costs, etc.) of the similar real estimate and present them in a manner enabling comparison with the real estate selected by the user.

This makes it possible to extract real estate information similar to a real estate selected by the user from the real estate information stored in the real estate management system, and provide information useful for real estate investment.

### Portfolio Analysis

For a portfolio consisting of multiple real estates in possession or under consideration for purchase selected by the user, the server 20 presents the results of analyses on the respective real estates in a manner enabling comparison. For example, the server 20 identifies the acquisition price, assessed value, borrowing balance, inheritance tax assessed value, and net operating income (NOI) of each of multiple real estimates in possession or under consideration for purchase selected by the user to perform a comparative analysis, and displays the analysis results in one graph.

Further, the server 20 extracts a given element of the possession information or purchase consideration information, performs a ratio analysis on the given element of each real estate, and presents the analysis results in a manner enabling comparison. For example, the server 20 performs a ratio analysis on the acquisition price of each real estate in a portfolio consisting of multiple real estates in possession or under consideration for purchase selected by the user, and displays the ratio of the acquisition price of each real estate to the total acquisition price of the multiple real estates in one graph.

For a portfolio consisting of multiple real estates in possession or under consideration for purchase selected by the user, the server 20 may present the results of analyses on future business conditions of the respective real estates in a manner enabling comparison. For example, the server 20 predicts future net operating incomes (NOIs) of multiple real estates in possession or under consideration for purchase selected by the user to perform a comparative analysis, and displays the future NOIs of the multiple real estates in one graph.

This enables presentation of the analysis results for the portfolio consisting of multiple real estates in possession or under consideration for purchase selected by the user in a manner enabling comparison, so that information useful for real estate investment can be provided, such as comparing a real estate under consideration for purchase with a real estate in possession or evaluating the business condition of a real estate portfolio.

### Borrowing Status Analysis

The server 20 performs a borrowing status analysis on each real estate in possession or under consideration for purchase selected by the user. For example, the server 20 performs a borrowing status analysis on the borrowing balance, cash flow, cumulative cash flow, and the like of each real estate on the basis of the operating income, operating expenses, repair costs, income tax, elapsed years, borrowing date, borrowing amount, contract borrowing period, borrowing interest, and the like of the real estate.

Further, the server 20 performs an overall borrowing status analysis on multiple real estates in possession or under consideration for purchase selected by the user, such as predicting a future overall cash flow. For example, the server 20 performs a borrowing status analysis on multiple real estates selected by the user for the future overall borrowing balance, cash flow, cumulative cash flow, and the like on the basis of the operating income, operating expenses, repair costs, income tax, elapsed years, borrowing date, borrowing amount, contract borrowing period, borrowing interest, and the like of each of the real estates.

As a result, for at least one real estate in possession or under consideration for purchase selected by the user, not only a borrowing state analysis for each real estate, but also a borrowing state analysis for a combination of multiple real estates can be performed. For example, a borrowing state analysis can be performed for the case where a real estate under consideration for purchase is purchased in addition to the real estates in possession. Therefore, information useful for real estate investment can be provided.

In step S524, the server 20 transmits the analysis results to the terminal apparatus 10. For example, the server 20 transmits to the terminal apparatus 10 the result of the income and expense analysis for a combination of real estates in possession and under consideration for purchase selected by the user.

In step S513, the terminal apparatus 10 displays the analysis result to present it to the user. For example, the terminal apparatus 10 displays the result of an income and expense analysis for a combination of real estates in possession and under consideration for purchase selected by the user to present it to the user.

By the above-described series of processes, it is possible to perform various types of analyses on at least one real estate in possession or under consideration for purchase selected by the user, and present the analysis result to the user. Therefore, information useful for real estate investment can be provided.

### Modifications

### Presentation of Information to Financial Institution

The server 20 may present to a financial institution the result of the analysis on at least one real estate selected from the possession information or the purchase consideration information. For example, the server 20 provides the financial institution with information indicating the income and expense analysis and borrowing status analysis of real estates in the possession of a given user and information on a real estate under consideration for purchase. For example, a terminal apparatus of the financial institution receives, from a user of the financial institution, an input of a search condition to search for a user who manages real estate. The server 20 refers to the user information database 281 and the real estate information database 282 in response to the search condition input at the terminal apparatus of the financial institution, and transmits information of the user who manages real estate, which is the search result, to the terminal apparatus of the financial institution. For example, the server 20 receives an input of a search condition based on the items of the user information database 281 or the items of the real estate information database 282 from a user of the financial institution. Specifically, the server 20 may receive, from the user of the financial institution, an input of a search condition regarding real estates “under consideration for purchase” by the user who manages real estate. For example, the server 20 receives as a search condition the borrowing amount necessary for acquiring a real estate “under consideration for purchase”.

Further, the server 20 may transmit, to the terminal apparatus of the financial institution, information such as “in possession”, “under consideration for purchase”, “consideration suspended”, “sold”, and the like set for each real estate by each user who manages real estate, based on the user information database 281. The server 20 may enable the user of the financial institution to send a message or the like to a user who manages real estate. This enables the user of the financial institution to offer to lend to each user who manages real estate while confirming information on the real estates in the possession of the user who manages real estate and the real estate under consideration for purchase by the user.

As a result, the financial institution can easily confirm necessary basic real estate information (lease status list, monthly income and expense table, annual performance table, repair history table, borrowing status list, etc.). In addition, since the financial institution can propose a loan to the user when it determines that the user’s collateral valuation greatly exceeds the borrowing balance, the financial institution can provide a matching service between real estate managers who wish to borrow purchase funds and financial institutions who wish to lend.

### Sub User Registration

The server 20 may receive from the user an operation to register a sub user ID associated with his/her own user ID (main user ID) and create at least one sub user ID. For example, when the user inputs a mail address, the server 20 creates a sub user ID corresponding to the mail address. Thus, the sub user can access the information of the main user.

Further, the server 20 may manage the authority of each sub user in accordance with a main user’s setting. For example, the main user designates a real estate ID of real estate information accessible by each sub user, which enables the sub user to access only specific real estates in the possession of the main user. In addition, the main user may limit operations that each sub user can perform on real estate information. For example, a main user’s setting enables a given sub user to browse information on a given real estate in the possession of the main user and register new real estate information.

The server 20 may allow a transfer of a sub user ID among main users, or a promotion of a sub user ID to a main user ID. As an example of the transfer of a sub user ID among main users, let us assume that there are a first main user “user 1”, a second main user “user 2”, and a first sub user “user 3” associated with the first main user “user 1”. Let us also assume that the first main user “user 1” is a real estate management company of the first sub user “user 3”. The association between the first sub user “user 3” and the first main user “user 1” is canceled, and the first sub user “user 3” is associated with the second main user “user 2”. For example, the first main user “user 1” and the second main user “user 2” may or may not have some relationship with each other, such as being companies in the same group or sibling branches. For example, the first sub user “user 3” is transferred between the first main user “user 1” and the second main user “user 2” due to some circumstances in which the management jurisdiction of the first sub user “user 3” is changed to the second main user “user 2”.

Further, the server 20 may allow a sub user to access information on the main user’s real estates in response to satisfying a predetermined condition, while not allowing the sub user to access the information on the main user’s real estates until the predetermined condition is satisfied. Here, satisfying the predetermined condition includes the main user reaching a specific state.

For example, the main user here may be a decedent, and the sub user may be an heir. The main user, who is a decedent, designates at least one heir as a sub user, so that the heir can access information on real estates in the possession of or under consideration for purchase of the decedent, and the like. This makes it possible to easily share the real estate information of the main user with the sub users, and provide information useful for inheritance negotiation. It also makes it possible to propose selling, purchasing, or liquidating real estate as an inheritance measure on the basis of the result of the real estate analysis. Here, the server 20 may enable a sub user to share the real estate information of the main user in response to information indicating a situation where the sub-user inherits from the sub user. For example, in response to the server 20 receiving a notification that the main user, who is the decedent, has passed away, the server may allow the sub user to access the real estate information of the main user.

Alternatively, for example, the main user here may be a real estate manager, and the sub user here may be an expert such as a tax accountant, a lawyer, a real estate appraiser, or a real estate management company. The main user who is a real estate manager designates the expert as a sub user so that the expert can access information on real estates in the possession of and under consideration for purchase by the real estate manager and the like. This enables real estate information of the main user to be easily shared with the sub user. Further, the server 20 may associate the same expert sub user ID with multiple main user IDs. For example, the server 20 assigns one sub user ID to a tax accountant and associates the sub user ID with main user IDs of multiple real estate managers, and displays the user names of the main user IDs for the sub user ID.

### 4 Screen Example

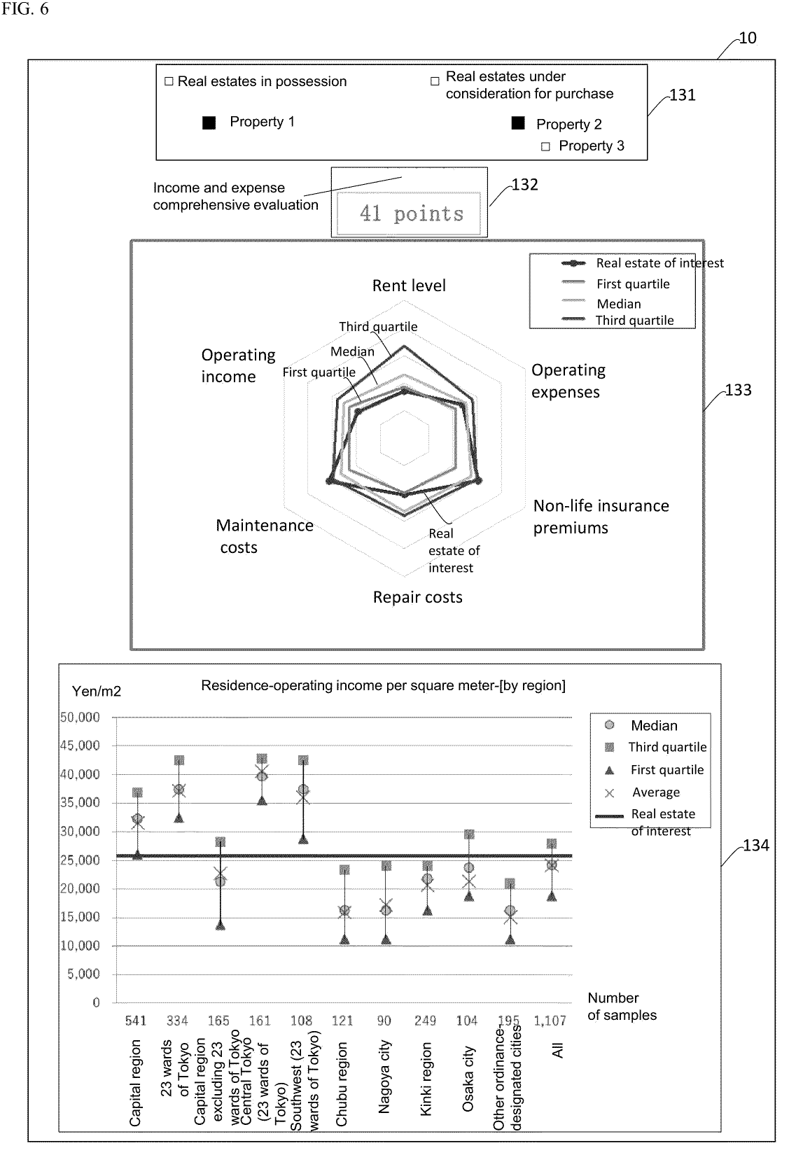

FIGS. 6, 7, and 8 are views showing screen examples of the terminal apparatus according to the present disclosure, and display results of respective analyses.

FIG. 6 is a screen example showing a result of an income and expense analysis performed on multiple real estates selected by the user. As shown in FIG. 6, on the terminal apparatus 10, an area for selecting a real estate is displayed in an area 131. The real estates registered by the user are presented according to their status (in possession, under consideration for purchase, etc.), and the real estate selected by the user is shown as a black square (in FIG. 6, property 1 in possession and property 2 under consideration for purchase are selected).

This enables the user to narrow down the real estates to be analyzed by status, and can simultaneously designate and analyze multiple real estates in different statuses.

In an area 132, a parameter comprehensively evaluating the income and expense status of multiple real estates selected by the user is displayed. In FIG. 6, an “income and expense comprehensive evaluation”, which is a parameter comprehensively evaluating the income and expense status for the combination of property 1 in possession and property 2 in consideration of purchase, is displayed in numerical form.

In an area 133, as the income and expense status of multiple real estates selected by the user, the income and expense items (operating income, rent level, operating expenses, non-life insurance premiums, repair costs, maintenance costs, etc.) are displayed in the same graph. In FIG. 6, the income and expense status for the combination of property 1 in possession and property 2 under consideration for purchase (real estate of interest) is displayed in one radar chart (called a score map) for each income and expense item, and the income and expense items (operating income, rent level, operating expenses, non-life insurance premiums, repair costs, and maintenance costs) are displayed in the same graph. Further, the first quartile, median, and third quartile of each income and expense item calculated by extracting a predetermined sample number of real estates from the real estate information stored in the real estate management system 1 are displayed in the same graph as the income and expense status of the multiple real estates selected by the user.

In an area 134, each income and expense item of the multiple real estates selected by the user is displayed in detail. In FIG. 6, the operating income per square meter of the income and expense status for the combination of property 1 in possession and property 2 under consideration for purchase (real estate of interest) is shown as a straight line in the scatter diagram. The first quartile, median, average, and third quartile of the operating income per square meter of real estates in each region stored in the real estate management system 1 are displayed as dots in the scatter diagram in a manner enabling comparison with the real estate of interest. As well as the operating income per square meter, the operating expenses (comparison with real estates by total floor area), rent level (comparison with real estates by region), repair costs (comparison with real estates by age of building), maintenance costs (comparison with real estates by total floor area), operating balance (comparison with real estates by region), and the like of the real estate of interest selected by the user may be displayed.

This enables display of a comprehensive income and expense analysis result in an easy-to-see manner while displaying the analysis results of the income and expense items for multiple real estates in possession or under consideration for purchase selected by the user, and enables the user to easily grasp the income and expense status of these real estates.

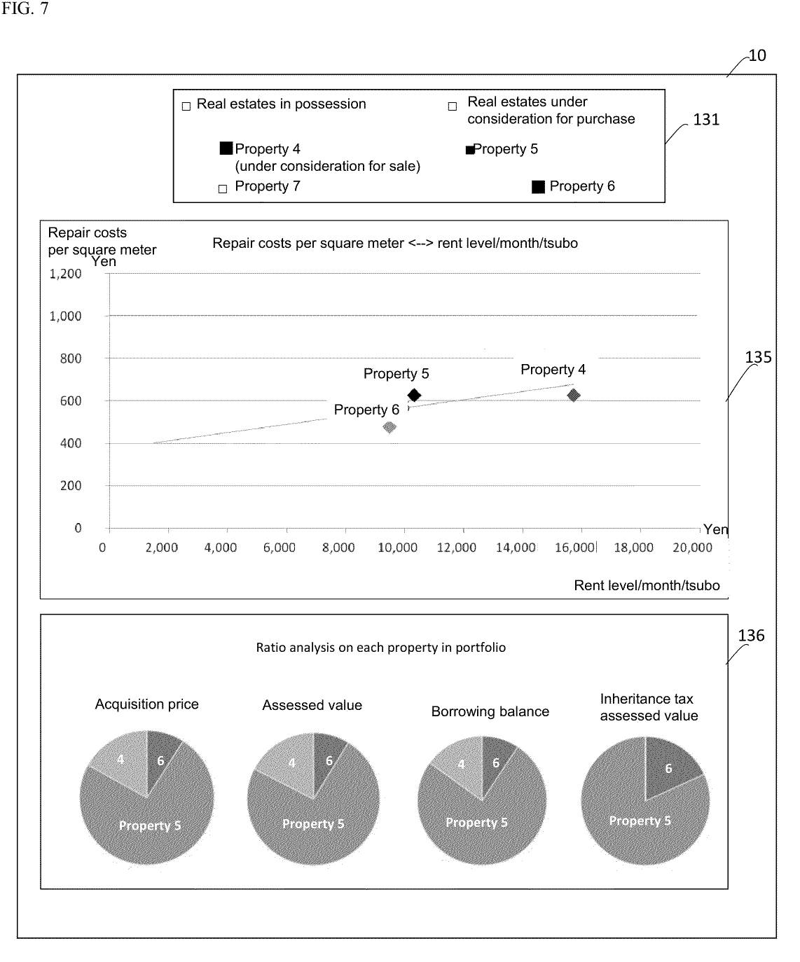

FIG. 7 is a screen example displaying the result of a comparative analysis performed on multiple real estates selected by the user. As shown in FIG. 7, on the terminal apparatus 10, an area for selecting a real estate is displayed in an area 131. The real estates registered by the user are presented according to their status (in possession, under consideration for purchase, under consideration for sale, etc.), and the real estate selected by the user is shown as a black square (in FIG. 7, property 4 in possession and properties 5 and 6 under consideration for purchase are selected).

This enables the user to narrow down the real estates to be analyzed by status, and can simultaneously designate and analyze multiple real estates in different statuses.

In an area 135, for a portfolio consisting of multiple real estates selected by the user, the results of analyses on the respective real estates are presented in a manner enabling comparison. In FIG. 7, the ratios of repair costs to rent level per square meter of property 4 in possession and property 5 in consideration for purchase are displayed in one graph in a manner enabling comparison, and the regression line obtained from the ratios of repair costs to rent level per square meter of the respective properties is also displayed in one graph. In addition to the ratios of repair costs to rent level per square meter, the ratio of net operating income (NOI) to acquisition price, ratio of NOI yield to acquisition price yield, ratio of NOI yield to rent level, ratio of inheritance tax assessed value to assessed value may be displayed for each real estate in the portfolio selected by the user.

In an area 136, a given element is extracted from a portfolio consisting of multiple real estates selected by the user, a ratio analysis is performed on the given element of each of the real estates, and the analysis results are presented in a manner enabling comparison. In FIG. 7, the ratios of each of the acquisition price, assessed value, borrowing balance, and inheritance tax assessed value of property 4 in possession and properties 5 and 6 under consideration for purchase to the total are shown in the corresponding pie graph in a manner enabling comparison. Further, the ratio analyses on multiple items may be displayed in a single graph in a manner enabling comparison. For example, the ratio analyses on the acquisition prices of the respective properties and the ratio analyses on the borrowing balances of the respective properties may be displayed in one double doughnut graph.

This enables presentation of the analysis results on the portfolio consisting of multiple real estates in possession or under consideration for purchase selected by the user in a manner enabling comparison, so that information useful for real estate investment can be provided, such as comparing real estates under consideration for purchase with real estates in possession. In addition, the analysis results for multiple real estates in the portfolio can be displayed in the same screen table, and can be presented in a form that is easy for the user to visibly recognize.

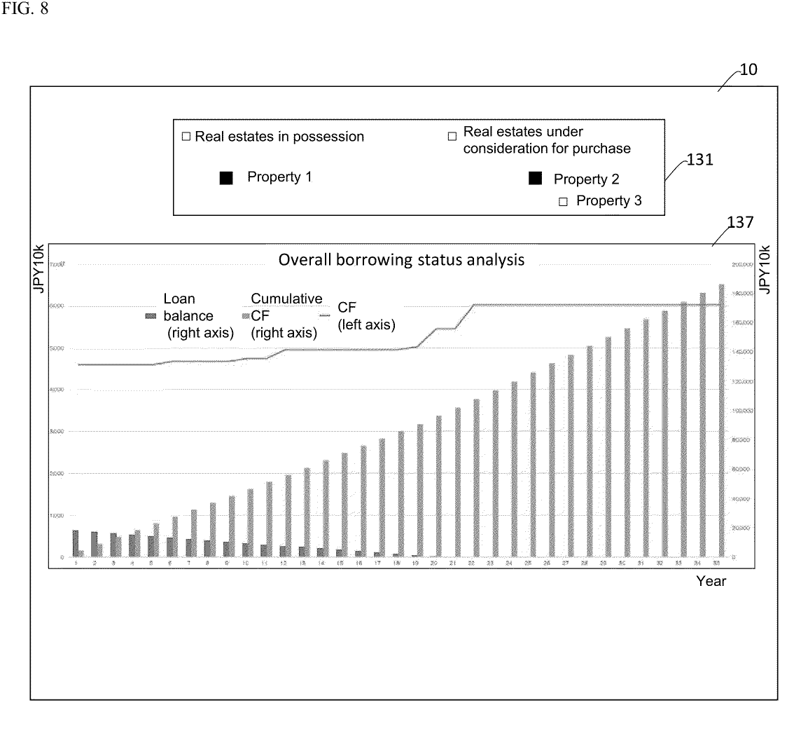

FIG. 8 is a screen example displaying the result of a borrowing status analysis performed on multiple real estates selected by the user. As shown in FIG. 8, on the terminal apparatus 10, an area for selecting a real estate is displayed in an area 131. The real estates registered by the user are presented according to their status (in possession, under consideration for purchase, etc.), and the real estate selected by the user is shown as a black square (in FIG. 8, property 1 in possession and property 2 under consideration for purchase are selected).

This enables the user to narrow down the real estates to be analyzed by status, and can simultaneously designate and analyze multiple real estates in different statuses.

In an area 137, an overall borrowing status of multiple real estates selected by the user is presented. In FIG. 8, the future overall borrowing balance (loan balance), cash flow, and cumulative cash flow for a combination of property 1 in possession and property 2 under consideration for purchase are presented. In the example of FIG. 8, the number of years elapsed is represented by the horizontal axis, and two types of bar graphs are displayed for each year. In the shown example, the bar graph on the left side of each year indicates the “borrowing balance (loan balance)” and the bar graph on the right side indicates the “cumulative cash flow”.

This enables presentation of the analysis result of the overall borrowing status of multiple real estates in possession or under consideration for purchase selected by the user, so that information useful for real estate investment can be provided, such as performing a cash flow simulation for a combination of real estates under consideration for purchase in addition to those in possession.

### Second Embodiment

In the above example, an embodiment has been described in which an analysis is performed on at least one real estate in possession or under consideration for purchase designated by the user. However, the data analyzed here is not limited to the real estate investment information, and may be data on at least one business operator or business under investment or under consideration for investment designated by the user. This makes it possible to provide the user with information useful for investment on a business operator or a business. The business operator here may be a listed company, an unlisted company, or any other organization engaged in business.

The business operator may have multiple businesses. The term “business” here may refer to a business area uniquely defined by a business operator. The term “business” may also refer to a generally established business classification, industry classification, or business field classification such as “retail business”, “transportation business”, or “restaurant business”. For example, a stock exchange sometimes assigns a business field classification together with a stock name. Also, industry classifications are sometimes shown in publications that contain information on listed companies. The business may also include businesses of real estate management and real estate investment.

### 1 Data Structure

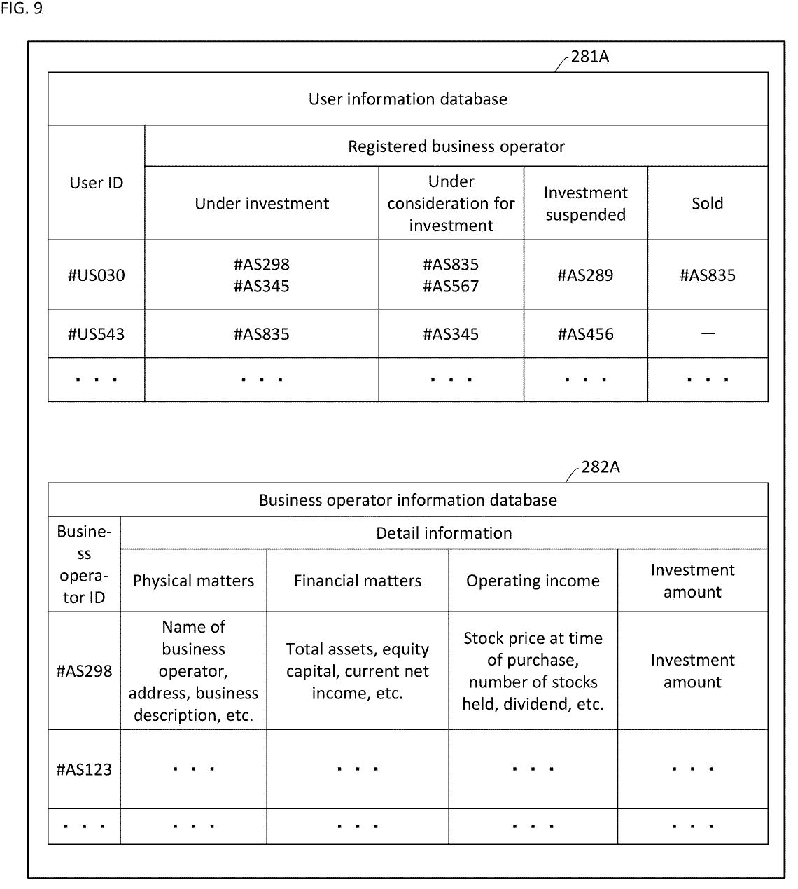

FIG. 9 shows data structures of a user information database 281A and a business operator information database 282A stored in the server 20.

As shown in FIG. 9, each record of the user information database 281A includes an item “user ID”, an item “registered business operator”, and the like.

The item “user ID” is information for identifying each user. In the user information database 281A, information on the name of the user or the like may be held in association with the information for identifying the user.

The item “registered business operator” is information on a business operator that each user registered when utilizing a business management system 200. Specifically, as the “registered business operator”, each business operator ID is stored according to the status of the business operator designated by the user (such as “under investment”, “under consideration for investment”, or “consideration suspended”).

For example, when the user registers detailed information of a business operator under investment, the server 20 refers to the user information database 281A and stores the business operator as a business operator “under investment” for the user. When the user searches a business operator from the business operators stored in the business management system 200 using a predetermined search condition (business type, area, listing category, keyword, etc.) and designates a business operator satisfying the search condition as a business operator under consideration for investment, the server 20 stores the business operator as a business operator under consideration for investment.

Each record of the business operator information database 282A includes an item “business operator ID”, an item “detailed information”, and the like. For each record in the business operator information database 282A, for example, the server 20 may receive a user’s operation to register information on the business operator and thereby update the user’s investment details (amount invested, purchase price when a stock is acquired, purchase time, etc.) in the business operator information database 282A in association with the information identifying the business operator. The server 20 may receive from the user an operation to register a business operator and thereby register information on the business operator in the business operator information database 282A. Further, the server 20 may register a business operator in the business operator information database 282A by crawling information of the business operator from the Web, the business company’s website, or the like.

The item “business operator ID” is information for identifying each business operator.

The item “detailed information” is detailed information on each business operator, and specifically includes physical matters, financial matters, investment income, investment amount, and the like of each business operator. Detailed information of business operators is used when performing an analysis on business operators.

The item “physical matters” is information for specifying each business operator, and specifically includes information on the name of the business operator, address, business description, history, officers, affiliated companies, and the like. The server 20 may hold the information of the business classification, industry classification, or business field classification of the business operator under the item “physical matters” or the like in association with the information of the business operator.

The item “financial matters” is information on the financial condition of each business operator, and specifically includes information on total assets, equity capital, current net income, number of issued stocks, stock price, and the like. The server 20 may hold information on the financial condition under the item “financial matters” in accordance with the business classification to which the business operator belongs. For example, when a business operator is engaged in the “retail” business, information that tends to attract attention in the business classification such as “inventory turnover rate” may be held as information on the financial condition under the item “financial matters” or the like. For example, when a business operator is engaged in the “restaurant” business, the server 20 may hold the turnover rate of customers visiting the restaurant as the information on the financial condition of the business.

The item “investment income” is information indicating the income obtained by continuing to invest in each business operator, and specifically includes information on the stock price at the time of purchase, the number of stocks held, dividend, and the like. For example, the server 20 may hold under the item “investment income” user’s information such as the stock price at the time of purchase, the number of shares held, the purchase time, and the sale time in association with the information of the user.

The item “investment amount” is information indicating the amount of money paid when investing in each business operator. For example, the server 20 may hold under the item “investment amount” information on the amount of money invested by the user and the time of investment in association with the information of the user.

### 2 Operation

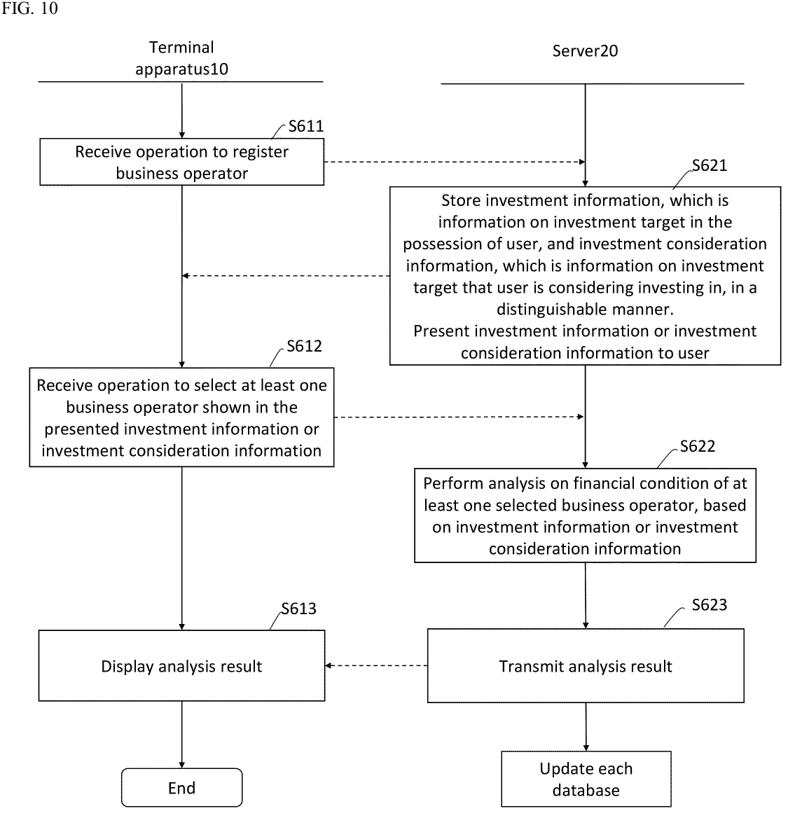

FIG. 10 is a flowchart showing an example of the flow of an analysis performed by the terminal apparatus 10 on at least one business operator under investment or under consideration for investment designated by the user.

In step S611, the terminal apparatus 10 receives from the user an operation to register a business operator. For example, the terminal apparatus 10 receives from the user an operation to input detailed information on a business operator under investment. Alternatively, the terminal apparatus 10 receives from the user an operation to designate a business operator satisfying a desired investment condition as a business operator “under consideration for investment”.

In step S621, the server 20 causes the storage unit 202 to store investment information, which is information on an investment target held by the user, and investment consideration information, which is information on an investment target the user is considering investing in, in a distinguishable manner. The server 20 presents the investment information or investment consideration information to the user. For example, the server 20 presents to the user various types of information (physical matters, form of right, operating income, operating expenses, etc.) of the business operators under investment or under consideration for investment by the user.

In step S612, the terminal apparatus 10 receives from the user an operation to select at least one business operator shown in the presented investment information or investment consideration information. For example, when the user wishes to know the financial condition when some business operators under consideration for investment are invested in in addition to all the business operators under investment, the user performs an operation to select all the business operators under investment and some business operators under consideration for investment.

In step S622, the server 20 performs an analysis on the financial condition of at least one selected business operator on the basis of the investment information or investment consideration information. For example, the server 20 performs the following analysis.

### Financial Analysis

The server 20 performs a financial analysis on at least one business operator under investment or under consideration for investment selected by the user.

### 1) Financial Analysis of Each Business Operator

The server 20 calculates, as items, the market capitalization, return on equity (ROE), return on assets (ROA), book-value per share (BPS), earnings per share (EPS), price sales ratio (PSR), price earnings ratio (PER), and the like of each business operator under investment or under consideration for investment selected by the user on the basis of the detailed information of the business operator to perform a financial analysis of the business operator.

Further, the server 20 may extract a predetermined sample number of business operators on the basis of the business operator information stored in the business management system 200 in addition to the business operator information registered by the user, and calculate values at predetermined positions when the values of the predetermined sample number of business operators are arranged based on the magnitude of the value for each item, such as the first quartile, median, and third quartile, of each item (market capitalization, ROE, ROA, BPS, EPS, etc.) to perform a comparative analysis with the corresponding item of each business operator under investment or under consideration for investment selected by the user. In this way, the server 20 enables comparison with a comparison value calculated based on the detailed information of the predetermined sample number of business operators for each of the items of the result of the financial analysis on each business operator selected by the user.

Further, the server 20 may calculate a parameter evaluating each business operator under investment or under consideration for investment selected by the user on the basis of the detailed information of the business operator. For example, the server 20 comprehensively evaluates the investment status of each business operator on the basis of each calculated item, and calculates an income and expense comprehensive evaluation parameter of the business operator in numerical form.

Further, the server 20 may predict each future item (market capitalization, ROE, ROA, BPS, EPS, etc.) of each business operator under investment or under consideration for investment selected by the user on the basis of the detailed information of the business operator to perform a future financial analysis on the business operator.

### 2) Financial Analysis of Multiple Business Operators

Based on the detailed information of multiple business operators under investment or under consideration for investment selected by the user, the server 20 calculates, as items, a market capitalization for a combination of the multiple business operators, averages such as ROE and ROA, a value based on an average such as variance, and values at predetermined positions when arranged based on the magnitude of the value, such as a first quartile, a median, and a third quartile, to perform a financial analysis for a combination of multiple business operators.

Further, the server 20 may extract a predetermined sample number of business operators on the basis of other users' information on business operators under investment or under consideration for investment, i.e., business operator information other than the business operator information registered by the user, and calculate the first quartile, median, and third quartile of each item (market capitalization, ROE, ROA, BPS, EPS, etc.) to perform a comparative analysis with the corresponding item for a combination of multiple business operators under investment or under consideration for investment selected by the user.

Alternatively, the server 20 may calculate a parameter evaluating for a combination of multiple business operators under investment or under consideration for investment selected by the user on the basis of the detailed information of the multiple business operators. For example, the server 20 comprehensively evaluates an investment status for a combination of multiple business operators on the basis of the items of the combination of multiple business operators, and calculates an income and expense comprehensive evaluation parameter for the combination of the multiple business operators in numerical form.

As a result, for at least one business operator under investment or under consideration for investment selected by the user, not only a financial analysis for each business operator, but also a financial analysis for a combination of multiple business operators can be performed. For example, a financial analysis can be performed for a combination of business operators under consideration for investment in addition to those under investment. Therefore, information useful for business operator investment can be provided.

Further, the server 20 may predict each future item (market capitalization, ROE, ROA, BPS, EPS, etc.) of multiple business operators under investment or under consideration for investment selected by the user on the basis of the detailed information of the multiple business operators to perform a future financial analysis on the combination of the multiple business operators.

### 3) Extraction of Businesses Operator Similar to Selected Businesses Operator

The server 20 extracts, based on a financial analysis on at least one business operator under investment or under consideration for investment selected by the user, business operator information similar to the at least one selected business operator from other users' investment information or investment consideration information.

For example, the server 20 extracts business operator information similar to the investment status of the business operator under consideration for investment selected by the user from other users' investment information. Further, the server 20 may calculate, based on the information of the extracted similar business operator, each item (market capitalization, ROE, ROA, BPS, EPS, etc.) of the similar business operator, and present the calculated item in a manner enabling comparison with the business operator selected by the user.

This makes it possible to extract business operator information similar to the business operator selected by the user from the business operator information stored in the business operator system and provide information useful for business operator investment.

### Portfolio Analysis

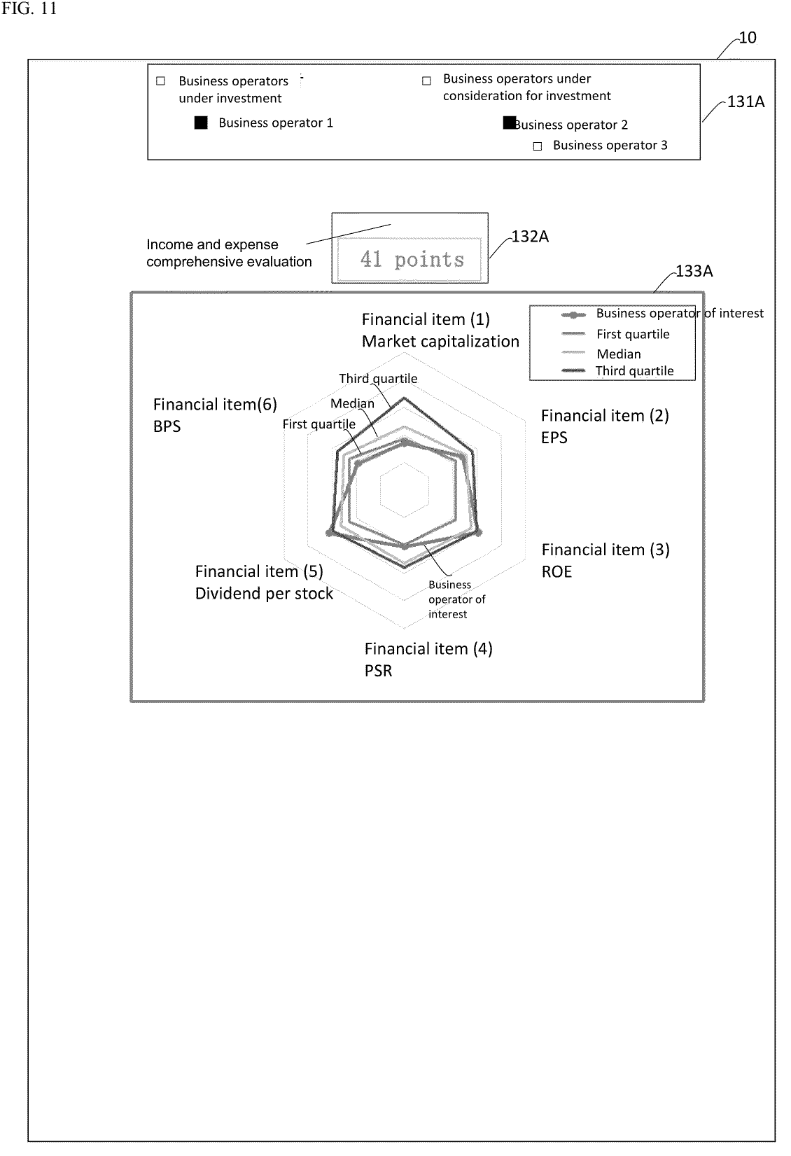

For a portfolio consisting of multiple business operators under investment or under consideration for investment selected by the user, the server 20 presents the results of analysis of the respective business operators in a manner enabling comparison. For example, the server 20 identifies multiple items such as the stock price per stock, dividend per stock, ROE, and ROA of each of multiple business operators under investment and under consideration for investment selected by the user to perform a comparative analysis, and displays the analysis results in which the items are associated with each other in one graph. For example, the results are displayed as shown in FIG. 11.

As shown in FIG. 11, the server 20 receives through a display section 131A from the user a designation of a business operator under investment and a designation of a business operator under consideration for investment. The server 20 displays, in a display section 132A, a parameter evaluating the goodness of the result of the financial analysis on the basis of the information of the business operators under investment or under consideration for investment designated by the user. In a graph display section 133A, the server 20 displays multiple financial items (six financial items are shown in the example shown) in association with each other by arranging the multiple financial items adjacent to each other into a polygonal shape. For each financial item, the server 20 displays information (“business operator of interest” in the example shown in FIG. 11) of the business operator under investment and business operator under consideration for investment designated by the user in a manner enabling comparison with the values of the financial items of a predetermined sample number of business operators. In the example shown, the values of the first quartile, median, and third quartile are displayed, as the values arranged based on the magnitude of the values of each financial item of the predetermined sample number of business operators, in a manner enabling comparison with information of the business operator designated by the user.

Further, the server 20 extracts a given element of the investment information or investment consideration information to perform a ratio analysis on the given element of each business operator, and presents the analysis results in a manner enabling comparison. For example, the server 20 performs a ratio analysis on the market capitalization of each business operator in a portfolio consisting of multiple business operators under investment or under consideration for investment selected by the user, and displays the ratio of the market capitalization of each business operator to the total investment amount of the multiple business operators in one graph.

For a portfolio consisting of multiple business operators under investment or under consideration for investment selected by the user, the server 20 may present the results of analyses on future investment statuses of the respective business operators in a manner enabling comparison.

This enables presentation of analysis results of a portfolio consisting of multiple business operators under investment or under consideration for investment selected by the user in a manner enabling comparison, so that information useful for business operator investment can be provided, such as comparing a business operator under investment with a business operator under consideration for investment or evaluating the investment status of a business operator portfolio.

In step S623, the server 20 transmits the analysis results to the terminal apparatus 10. For example, the server 20 transmits to the terminal apparatus 10 the result of the investment analysis for a combination of business operators under investment and under consideration for investment selected by the user.

In step S613, the terminal apparatus 10 displays the analysis result to present it to the user. For example, the terminal apparatus 10 displays the result of a financial analysis for a combination of business operators under investment and under consideration for investment selected by the user to present it to the user.

By the above-described series of processes, it is possible to perform various types of analysis on at lest one business operator under investment or under consideration for investment selected by the user, and present the analysis result to the user. Therefore, information useful for business operator investment can be provided.

### 3 Modification

In the above example, the server 20 is used to perform a financial analysis on a business operator designated by the user. However, the server 20 may perform a financial analysis on a business being run or under consideration for running by a business operator.

### Summary

As described above, according to the present disclosure shown in the first embodiment, it is possible to perform various types of analysis on at least one real estate, business operator, or business in possession or under consideration for purchase selected by the user, and present the analysis result to the user. Therefore, information useful for real estate investment can be provided.

According to the present disclosure shown in the second embodiment, it is possible to perform an analysis to provide information useful for investment on an investment target such as a business operator or a business.

### Appendixes

Matters described in each of the above embodiments will be added below.

Matters described in the first embodiment will be added below.

### Appendix 1

An information processing apparatus comprising a control unit (203) and a storage unit (202) and configured to provide real estate investment information to a user, wherein the storage unit (202) stores possession information, which is information on a real estate possessed by the user, and purchase consideration information, which is information on a real estate under consideration for purchase, in a distinguishable manner, and the control unit (203) performs: a real estate information presenting step (S522) for presenting the possession information or purchase consideration information to the user; a selection receiving step (S512) for receiving from the user an operation to select at least one real estate shown in the presented possession information or purchase consideration information; an analyzing step (S523) for performing an analysis on a business condition of the at least one selected real estate, based on the possession information or purchase consideration information; and an analysis result presenting step (S524) for presenting a result of the analysis.

### Appendix 2

The information processing apparatus according to Appendix 1, wherein the storage unit (202) stores sale consideration information, which is information on a real estate that the user is considering selling, in a distinguishable manner among the possession information.

### Appendix 3

The information processing apparatus according to Appendix 1 or 2, wherein the analyzing step (S523) includes performing an income and expense analysis on the at least one real estate selected from the possession information or purchase consideration information.

### Appendix 4

The information processing apparatus according to Appendix 3, wherein the information processing apparatus calculates, based on the income and expense analysis, a parameter evaluating a value of the at least one real estate selected from the possession information or purchase consideration information (S523).

### Appendix 5

The information processing apparatus according to Appendix 3, wherein the information processing apparatus extracts, based on the income and expense analysis, real estate information similar to the at least one real estate selected from the possession information or purchase consideration information of the user from possession information or purchase consideration information of another user.

### Appendix 6

The information processing apparatus according to Appendix 1 or 2, wherein the analyzing step (S523) includes presenting the result of the analysis on each real estate of the plurality of real estates selected from the possession information or purchase consideration information in a manner enabling comparison.

### Appendix 7

The information processing apparatus according to Appendix 6, wherein the information processing apparatus extracts a given element of the possession information or purchase consideration information, performs a ratio analysis on the given element of each real estate, and presents a result of the analysis in a manner enabling comparison (S523).

### Appendix 8

The information processing apparatus according to Appendix 1 or 2, wherein the analyzing step (S523) includes performing a borrowing status analysis on the at least one real estate selected from the possession information or purchase consideration information.

### Appendix 9

The information processing apparatus according to Appendix 8, wherein the information processing apparatus predicts a future overall cash flow of the plurality of real estates selected by the user, based on analysis results of an income and expense analysis and the borrowing status analysis (S523) .

### Appendix 10

The information processing apparatus according to any one of Appendices 1 to 9, wherein the information processing apparatus presents to a financial institution the result of the analysis on the at least one real estate selected from the possession information or purchase consideration information.

### Appendix 11

The information processing apparatus according to any one of Appendices 1 to 10, wherein the control unit receives an access from a terminal apparatus of another user who offers provision of funds to the user, and matches the user with the another user.

### Appendix 12

The information processing apparatus according to Appendix 11, wherein in the matching, the control unit receives from the another user an input of a search condition related to the real estate information of the user stored in the storage unit, and returns the user satisfying the search condition to the terminal apparatus of the another user.

### Appendix 13

An information processing apparatus comprising a control unit and a storage unit and configured to provide real estate investment information to a user, the control unit being configured to perform: presenting real estate information to the user; receiving an operation to select at least one presented real estate; performing an analysis on a business condition of the at least one selected real estate; and presenting a result of the analysis, wherein the performing an analysis includes performing an income and expense analysis on the at least one real estate selected by the user, and analyzing each of a plurality of income and expense items, the presenting includes presenting the income and expense items of the at least one selected real estate or the income and expense items of a combination of the plurality of selected real estates and comparison values of income and expense items calculated based on information on a predetermined sample number of real estates in a form that enables comparison therebetween on a same screen.

### Appendix 14

The information processing apparatus according to Appendix 13, wherein the presenting includes presenting, as the comparison value of each income and expense item of the income and expense items, at least one of a group consisting of a value based on an average of the information on the predetermined sample number of real estates or a value at a predetermined position when values of the income and expense item of the information on the predetermined sample number of real estates are arranged based on magnitude of the values in a form that enables comparison with the income and expense item of the selected real estate.

### Appendix 15

The information processing apparatus according to (Appendix 14), wherein the presenting includes presenting, as the comparison value of each income and expense item of the income and expense items, at least one of a group consisting of a first quartile, a median, an average, and a third quartile of the income and expense item calculated based on the information on the predetermined sample number of real estates in the form that enables comparison with the income and expense item of the selected real estate.

### Appendix 16

A program executed by a computer comprising a processor and a memory for providing real estate investment information to a user, wherein the program causes the processor to perform: presenting real estate information to the user; receiving an operation to select at least one presented real estate; performing an analysis on a business condition of the at least one selected real estate; and presenting a result of the analysis, wherein the performing an analysis includes performing an income and expense analysis on the at least one real estate selected by the user, and analyzing each of a plurality of income and expense items, the presenting includes presenting the income and expense items of the at least one selected real estate or the income and expense items of a combination of the plurality of selected real estates and comparison values of income and expense items calculated based on information on a predetermined sample number of real estates in a form that enables comparison therebetween on a same screen.

### Appendix 17

A method executed by a computer comprising a processor and a memory for providing real estate investment information to a user, the method comprising the following steps performed by the processor: presenting real estate information to the user; receiving an operation to select at least one presented real estate; performing an analysis on a business condition of the at least one selected real estate; and presenting a result of the analysis, wherein the performing an analysis includes performing an income and expense analysis on the at least one real estate selected by the user, and analyzing each of a plurality of income and expense items, the presenting includes presenting the income and expense items of the at least one selected real estate or the income and expense items of a combination of the plurality of selected real estates and comparison values of income and expense items calculated based on information on a predetermined sample number of real estates in a form that enables comparison therebetween on a same screen.

Matters described in the second embodiment will be added below.

### Appendix 2-1

An information processing apparatus comprising a control unit and a storage unit and configured to provide investment information to a user, wherein the control unit performs: presenting information of each business operator or business that is a candidate for investment to the user; receiving an operation to select at least one business operator or business from the user; performing an analysis on a financial condition of at least one selected business operator or business; and presenting a result of the analysis, wherein the performing an analysis includes performing a financial analysis based on information of the at least one business operator or business selected by the user and analyzing each of a plurality of financial items, and the presenting includes creating one graph in which the financial items of the selected business operator or business or the financial items of a combination of the selected business operators or businesses are associated with each other and presenting in the graph the financial items and comparison values of financial items of each of a predetermined sample number of business operators or businesses in a form that enable comparison therebetween on the same screen.

### Appendix 2-2

The information processing apparatus according to (Appendix 2-1), wherein the presenting includes presenting, as the comparison value of each financial item of the financial items, at least one of a group consisting of a value based on an average of the predetermined sample number of business operators or businesses or a value at a predetermined position when values of the financial item of the predetermined sample number of business operators or businesses are arranged based on magnitude of the values in a form that enables comparison with the financial item of the selected business operator or business.

### Appendix 2-3

The information processing apparatus according to (Appendix 2-2), wherein the presenting includes presenting, as the comparison value of each financial item of the financial items, at least one of a group consisting of a first quartile, a median, an average, and a third quartile of the financial item calculated based on information on the predetermined sample number of business operators or businesses in the form that enables comparison with the financial item of the selected business operator or business.

### Appendix 2-4

The information processing apparatus according to (Appendix 2-3), wherein the information processing apparatus calculates, based on the financial analysis, a parameter evaluating the financial condition of the at least one business operator or business selected from information of a company under investment or information of a company under consideration for investment.

### Appendix 2-5

The information processing apparatus according to any one of (Appendix 2-1) to (Appendix 2-4), wherein the financial items include at least items of return on equity (ROE) and return on assets (ROA).

### Appendix 2-6

The information processing apparatus according to any one of (Appendix 2-1) to (Appendix 2-5), wherein the financial items include at least items of book-value per share (BPS) and earnings per share (EPS).

### Appendix 2-7

A program executed by a computer comprising a processor and a memory for providing investment information to a user, the program causing the processor to perform: presenting information of each business operator or business that is a candidate for investment to the user; receiving an operation to select at least one business operator or business from the user; performing an analysis on a financial condition of at least one selected business operator or business; and presenting a result of the analysis, wherein the performing an analysis includes performing a financial analysis based on information of the at least one business operator or business selected by the user and analyzing each of a plurality of financial items, and the presenting includes creating one graph in which the financial items of the selected business operator or business or the financial items of a combination of the selected business operators or businesses are associated with each other and presenting in the graph the financial items and comparison values of financial items of each of a predetermined sample number of business operators or businesses in a form that enable comparison therebetween on the same screen.

### Appendix 2-8

A method executed by a computer comprising a processor and a memory for providing investment information to a user, the method comprising the following steps performed by the processor: presenting information of each business operator or business that is a candidate for investment to the user; receiving an operation to select at least one business operator or business from the user; performing an analysis on a financial condition of at least one selected business operator or business; and presenting a result of the analysis, wherein the performing an analysis includes performing a financial analysis based on information of the at least one business operator or business selected by the user and analyzing each of a plurality of financial items, and the presenting includes creating one graph in which the financial items of the selected business operator or business or the financial items of a combination of the selected business operators or businesses are associated with each other and presenting in the graph the financial items and comparison values of financial items of each of a predetermined sample number of business operators or businesses in a form that enable comparison therebetween on the same screen.

### Appendix 2-9

Provided is an information processing apparatus comprising a control unit and a storage unit and configured to provide business operator or business investment information to a user. The control unit performs: a selection receiving step for receiving from the user an operation to select at least one business operator or business shown in presented investment information or investment consideration information; an analyzing step for performing an analysis on a financial condition of the at least one selected business operator or business, based on the investment information or investment consideration information; and presenting a result of the analysis. The presenting includes presenting on the same screen the financial items of the selected business operator or business or the financial items of a combination of the selected business operators or businesses and values at predetermined first and second positions when values of each financial item of a predetermined sample number of business operators or businesses are arranged in a form that enable comparison therebetween.

### EXPLANATION OF REFERENCE NUMERALS

10: terminal apparatus, 20: server, 80: network, 22: communication IF, 23: input/output IF, 25: memory, 26: storage, 29: processor, 201: communication unit, 202: storage unit, 281: user information database, 282: information database, 203: control unit

1. An information processing apparatus comprising a control unit and a storage unit and configured to provide investment information to a user,
the control unit being configured to perform:
presenting information of each business operator or business that is a candidate for investment to the user;
receiving an operation to select at least one business operator or business from the user;
performing an analysis on a financial condition of the at least one selected business operator or business; and
presenting a result of the analysis, wherein
the performing an analysis includes performing a financial analysis based on information of the at least one business operator or business selected by the user and analyzing each of a plurality of financial items, and
the presenting the result includes creating one graph in which the financial items of the selected business operator or business or the financial items of a combination of the selected business operators or businesses are associated with each other and presenting in the graph the financial items and comparison values of financial items of each of a predetermined sample number of business operators or businesses in a form that enable comparison therebetween on a same screen.

2. The information processing apparatus according to claim 1, wherein the presenting the result includes presenting, as the comparison value of each financial item of the financial items, at least one of a group consisting of a value based on an average of the predetermined sample number of business operators or businesses or a value at a predetermined position when values of the financial item of the predetermined sample number of business operators or businesses are arranged based on magnitude of the values in a form that enables comparison with the financial item of the selected business operator or business.

3. The information processing apparatus according to claim 2, wherein the presenting the result includes presenting, as the comparison value of each financial item of the financial items, at least one of a group consisting of a first quartile, a median, an average, and a third quartile of the financial item calculated based on information on the predetermined sample number of business operators or businesses in the form that enables comparison with the financial item of the selected business operator or business.

4. The information processing apparatus according to claim 3, wherein the information processing apparatus calculates, based on the financial analysis, a parameter evaluating the financial condition of the at least one business operator or business selected from information of a company under investment or information of a company under consideration for investment.

5. The information processing apparatus according to claim 1, wherein the financial items include at least items of return on equity (ROE) and return on assets (ROA).

6. The information processing apparatus according to claim 1, wherein the financial items include at least items of book-value per share (BPS) and earnings per share (EPS).

7. A non-transitory computer-readable recording medium that stores a program which causes a computer to execute a method for providing investment information to a user, the method comprising:
presenting information of each business operator or business that is a candidate for investment to the user;
receiving an operation to select at least one business operator or business from the user;
performing an analysis on a financial condition of the at least one selected business operator or business; and
presenting a result of the analysis, wherein
the performing an analysis includes performing a financial analysis based on information of the at least one business operator or business selected by the user and analyzing each of a plurality of financial items, and
the presenting the result includes creating one graph in which the financial items of the selected business operator or business or the financial items of a combination of the selected business operators or businesses are associated with each other and presenting in the graph the financial items and comparison values of financial items of each of a predetermined sample number of business operators or businesses in a form that enable comparison therebetween on a same screen.

8. A method executed by a computer comprising a processor and a memory for providing investment information to a user, the method comprising the following steps performed by the processor:
presenting information of each business operator or business that is a candidate for investment to the user;
receiving an operation to select at least one business operator or business from the user;
performing an analysis on a financial condition of the at least one selected business operator or business; and
presenting a result of the analysis, wherein
the performing an analysis includes performing a financial analysis based on information of the at least one business operator or business selected by the user and analyzing each of a plurality of financial items, and
the presenting the result includes creating one graph in which the financial items of the selected business operator or business or the financial items of a combination of the selected business operators or businesses are associated with each other and presenting in the graph the financial items and comparison values of financial items of each of a predetermined sample number of business operators or businesses in a form that enable comparison therebetween on a same screen.
